(19) United States
(12) Patent Application Publication
(10) Pub. No.: US 2012/0040863 A1
(43) Pub. Date: Feb. 16, 2012

(54) PROCESS FOR TUMOUR CHARACTERISTIC AND MARKER SET IDENTIFICATION, TUMOUR CLASSIFICATION AND MARKER SETS FOR CANCER

(75) Inventors: Edwin Wang, Laval (CA); Jie Li, Montreal (CA); Yinghai Deng, Dorval (CA); Anne E. G. Lenferink, Lorraine (CA); Maureen D. O'Connor-McCourt, Beaconsfield (CA); Enrico Purisma, Pierrefonds (CA)

(73) Assignee: National Research Council of Canada

(21) Appl. No.: 13/263,426

(22) PCT Filed: Apr. 16, 2010
(86) PCT No.: PCT/CA10/00565

§ 371 Date: Oct. 7, 2011

Related U.S. Application Data
(60) Provisional application No. 61/202,881, filed on Apr. 16, 2009.

(51) Int. Cl. C40B 30/04

(52) U.S. Cl. 506/9

(57) ABSTRACT

A process to identify tumour characteristics involves obtaining three different marker sets each predictive of a characteristic of interest, obtaining a sample gene expression signals from tumour cells, adding a reporter to affect a change in the sample permitting assessment of a gene expression signal of interest in the tumour, combining the gene expression signals with the reporter, correlating the extracted gene expression signals to the three different marker sets, assigning a designation to the extracted gene expression signals according to the following rankings: if the correlation of all three predictive gene expression signal sets predict it to have characteristics of concern, it is designated a bad tumour; if the correlation of all three predictive gene expression signal sets predict it to lack characteristics of concern it is designated a good tumour; and, if the correlation of all three predictive gene expression signal sets do not provide the same predicted clinical outcome, the tumour is designated as “intermediate”; and, outputting said designation.

### FIELD OF THE INVENTION

The invention relates to the field of cancer biomarkers, and a process for their identification and use.

### BACKGROUND TO THE INVENTION

The more one knows about a cancer, the more effectively it can be treated. For example, most cancer patients have surgery. However, additional benefits may be possible with additional treatment for some patients. There is not currently a satisfactory approach to determine which patients with cancer would benefit from extra therapy (such as chemotherapy) after surgery. The identification of genes and proteins specific to cancer cells that can be used for prognostic purposes would be helpful in this regard. These genes/proteins which identify tumours associated with a poor prognosis for recovery if treated only by surgery followed by typical standard of care are called poor prognostic biomarkers. These biomarkers can be used as valuable tools for predicting survival after a diagnosis of cancer, for identifying patients for whom the risk of recurrence is sufficiently low that the patient is likely to progress as well or better in the absence of post-surgery chemotherapy and/or radiation treatment or with only typical standard of care treatment post-surgery, and for guiding how oncologists should treat the cancer to obtain the best outcome.

Similarly, there are genes expressed in cancers which play a role in drug response. It would be useful to have information on predicted drug response when making clinical decisions.

To provide a screening tool with sufficient precision to be of clinical interest, it should preferably consider multiple markers for a type of cancer. A single gene marker does not provide a sufficient level of specificity and sensitivity. By way of example, microarray technology, which can measure more than 25,000 genes at the same time provides a useful tool to find multi-markers.

It is an object of the invention to provide sets of markers for use in identifying tumour characteristics of interest and a process for their identification and use.

### SUMMARY OF THE INVENTION

The present invention in one embodiment teaches the usage of gene expression profiles to distinguish ‘good’ and ‘bad’ tumours based on groups of genes. As used herein when referring to predictors and patient survival, the term “good tumour” refers to a tumour which is likely to be cured by surgery and only typical standard of care, without chemotherapy or radiation treatment (even if this is part of the typical standard of care). As used herein, the term “bad tumour” refers to a tumour which is not likely to be cured by surgery and only typical standard of care including chemotherapy or radiation treatment. As used herein, a tumour is “cured” if the patient has not experienced a recurrence of the tumour (or a metastasis of it) within 5 or 10 years of surgery.

It is possible to identify sets of genes whose expression profiles are able to distinguish ‘good’ and ‘bad’ tumours. The prior art discloses five such gene expression signal sets and these have been developed as biomarkers for breast cancer samples. Each gene expression signal set was derived from a set of breast tumour samples. However, these five biomarker sets can't be cross-used. Specifically, the prior art so-called “breast cancer biomarkers” have not been found to be consistently predictive of prognosis when used in another set of breast tumour samples. Biomarkers for other types of cancers have the same problem. Cancer is highly heterogeneous. Frequently for a type of cancer several subtypes can be found. Previously disclosed marker sets are not universal enough for these subtypes.

To overcome these problems and the limitation of dataset (sample) availability, a new approach to finding and using sets of biomarkers was developed.

In one embodiment of the invention, random training datasets were generated from a published cancer dataset, in which gene expression profiles and clinical information of the patients had been included, to find robust sets of biomarkers'. Gene expression profiles of the random training dataset were correlated with patient survival status and to screening biomarkers.

In one embodiment of the invention there is provided a method of identifying biomarkers, said method comprising:
Generating a random training dataset from currently available datasets (tumour microarray profiling+clinical information of cancer patients)
Screening gene expression signal sets against the random training dataset to identify gene expression signal sets having predictive power for prognosis
Ranking genes based on the frequencies they appeared in the gene expression signal sets which have good predictive power (via screening, last step) and thereby building biomarker sets
Combinatory use of use 3-6 biomarker sets for prediction (i.e., Sample A is predicted by all three biomarker sets as “good tumour”, we will say Sample A is a “good tumour” (low-risk), If all say it is “bad”, we will say it is “bad” (high-risk), otherwise, we say it is intermediate-risk)
Validating the markers using other independent datasets

A “gene expression signal” is a tangible indicator of expression of a gene, such as mRNA or protein.

In an embodiment of the invention there is provided a process to identify tumour characteristics, said process comprising the following steps:
1) obtaining three different marker sets each predictive of a characteristic of interest;
2) extracting gene expression signals from tumour cells;
3) correlating the extracted gene expression signals to the three different marker sets;
4) assigning a value to the extracted gene expression signals according to the following rankings:
   a. if the correlation of all three predictive gene expression signal sets predict it to have characteristics of concern, it is designated a bad tumour;
   b. if the correlation of all three predictive gene expression signal sets predict it to lack characteristics of concern it is designated a good tumour;
   c. if the correlation of all three predictive gene expression signal sets do not provide the same predicted clinical outcome, the tumour is designated as “intermediate.”

In some cases, the characteristic of concern relates to one or more of: metastisis, inflammation, cell cycle, immunological response genes, drug resistance genes, and multi-drug resistance genes. In some cases the tumour characteristic is responsible to a particular treatment or combination of treatments.

In some cases the tumour characteristic is a tendency to lead to poor patient survival post-surgery.

In some cases, the tumour characteristic is related to patient survival and step 4 of the process above comprises assigning a value to the extracted gene expression signals according to the following rankings:
a. if the correlation of all three predictive gene expression signal sets predict it to be a bad tumour, it is designated a bad tumour and more aggressive treatment beyond the typical standard of care would be recommended;
b. if the correlation of all three predictive gene expression signal sets predict it to be a good tumour, no treatment beyond the standard of care would be recommended and no post-surgery chemotherapy or radiation treatment would be recommended;
c. if the correlation of all three predictive gene expression signal sets do not provide the same prognosis, the tumour is designated as “intermediate” and the full typical standard of care treatment, including chemotherapy and/or radiation treatment would be recommended.

In cases where the cancer has more than one subtype, it may be desirable to include the preliminary steps of:
a) identifying the tumour subtype to be examined;
b) selecting marker sets specific to that subtype of tumour.

In some cases, the tumour characteristic of interest is the tendency of the tumour to respond to particular treatments, such as chemotherapeutic agents or radiation. In such a case, the gene expression signals are correlated with tumour drug response in the process of developing the training sets. It will be understood that a “good” tumour response to a particular drug would be below-average tumour survival following treatment and a “bad” response would be above-average tumour survival following treatment. Using this approach, and depending on the detail available in the original tumour and clinical data used in developing the training sets, it is possible to develop markers not only for response to individual drugs or treatments, but to combinations of treatments (where there is sufficient data in the original source to permit this).

In an embodiment of the invention there is provided a process for determining predictive gene expression signal sets of the type useful in the processes described above comprising the following steps:
1) obtaining gene expression signal information and patient clinical information for a characteristic of interest for a known tumour population for a cancer of interest;
2) correlating the gene expression signals with clinical patient information regarding the characteristic of interest to identify which genes have predictive power for clinical outcome;
3) creating at least 30 random training datasets from step 1;
4) comparing identified gene expression signals of step 3 to a list of known genes active in cancer;
5) selecting identified gene expression signals which correspond to those on the list of known cancer genes;
6) grouping the selected identified gene expression signals according to their role in biological processes;
7) generating random gene expression signal sets of at least 25 genes from a selected gene expression signals group of step 6;
8) correlating the random gene expression signal sets to the random training datasets of step 3;
9) obtaining a P value for a survival screening from the correlation for each gene expression signal set of step 7;
10) if the P value for a gene expression signal set is less than 0.05 for more than 90% of the random training datasets, keeping the gene expression signal set;
11) ranking the random gene expression signal sets kept in step 10 based on frequency of gene appearances in the set;
12) selecting the top at least 26 genes as potential candidate markers;
13) repeating steps 7 to 12 and producing another, independent, rank set of at least 26 genes;
14) comparing the top genes from step 12 and step 13;
15) if more than 25 of the genes are the same, the top genes are kept as marker sets;
16) twice repeating steps 7 to 15 to obtain three different marker sets;

In one embodiment of the invention there is provided a process of identifying patients in need of more or less aggressive treatment than the typical standard of care, said process comprising:
A “gene expression signal” is a tangible indicator of expression of a gene, such as mRNA (in theory, could one measure protein expression instead if it was technically feasible to do so? Anything else?).
1. An information source comprising tumour and clinical patient information is studied individually. All reported gene expression signals in cells are correlated with patient survival (5 and 10 yrs) in order to identify which genes have predictive power for prognosis within that individual information source. Those gene expression signals found to correlate significantly with patient survival are identified for further examination.
2. Gene expression signals identified in step 1 are compared to a list of known cancer genes and those gene expression signals corresponding to known genes known to have a role in cancer are selected for further analysis. (this will generally give rise to a list of a few hundred to a few thousand gene expression signals)
3. At least 30 (typically between 30 and 40) random training datasets are produced from the information source of step 1. The same individual gene expression signal may appear in multiple random training datasets.
4. Gene expression signals selected in step 2 are grouped according to their role in biological processes (e.g. cell cycle genes, cell death genes, immunological response genes, inflammation genes and so on Go analysis
5. Random gene expression signal sets (typically about a million) are generated, each containing approximately 30 genes randomly selected from a single group produced in step 3.
6. A P value for a survival screening of each random gene expression signal sets of step 4 against each random training datasets is obtained Can you please describe this correlation a bit more?
7. If the P value is less than 0.05 for more than 90% of the random datasets, the random gene set is kept
8. The kept random gene expression signal sets from step 7 are ranked based on the frequencies of the genes appearing in them
9. The top 30 genes (ranked in Step 8) having the highest predictive value as determined in step 8 are selected as potential candidates.
10. Steps 5-9 are repeated, starting from the generation of random gene expression signal sets from each group formed in step 3, and producing another, independent, ranked set of the top 30 genes which are potential candidates.
11 The top 30 genes produced in step 10 are compared to the top 30 genes from step 9. If 25 or more of the 30 are the same, it is called a “stable signature” and is useful in screening patient samples. If fewer than 25/30 are the same, the data is discarded (from both sets of potential candidates). (At least 25 are needed, thus either the first or the second set of potential candidates may be used.
12. Steps 5-11 are repeated twice more for two other groups (of step 3) of gene expression signals. Thus, there will be three sets of stable signatures, each relating to a different group from step 3.
13. Cancer cells from the patient are examined to assess their gene expression activity and its correlation to the gene expression signals in the three stable signatures. Typically, a stable signature will be an indication of likelihood of metastasis and therefore high patient expression matching that signature will indicate a “bad” tumour. However it is possible that a stable signature might indicate protective genes being expressed, such as apoptosis genes, in which case, for that signature, high patient expression of those gene expression signatures would indicate a “good” tumour. In either case, each stable signature is compared to the patient sample and a prediction of “good” or “bad” tumour is made by each stable signature individually. What is the threshold for an indication of “bad” or “good” from a single stable signature? Eg. Is it “bad” if over 50% of the genes found in the signature are expressed in the sample? Is it “bad” if over 50% of the genes found in the signature are expressed above normal basal levels in the corresponding non-cancerous tissue?
14. Combining of the predictions of each of the three sets of gene expression signals as regards the patient sample and assigning a value to the tumour as follows: (a) if all three gene expression signal sets (signatures) predict it to be a bad tumour, it is designated a bad tumour and the patient should be provided more aggressive treatment beyond the typical standard of care; (b) if all three data sets predict it to be a good tumour the patient should receive no treatment beyond the standard of care and should not be subjected to post-surgery chemotherapy or radiation treatment; (c) if all three sets of gene expression products do not provide the same prognosis, the tumour is designated as “intermediate” and the patient should receive the full typical standard of care treatment, including chemotherapy and/or radiation treatment.

In some cases, for this process it will be desirable to group the selected identified gene expression signals according to their role in biological process using Gene Ontology analysis.

Preferably between 30 and 50 random training sets are created. More preferably, between 30 and 40 training sets are created.

It will sometimes be desirable to select the genes know to be active in cancer from the groups of genes responsible for metastasis, cell proliferation, tumour vascularisation, and drug response.

In some embodiments of the invention involving the process described above, in step 7, between about 750,000 and 1,250,000, or between about 900,000 and 1,100,000 or about a million random gene expression signal sets are generated. In some embodiments of the invention as described in the process above, in step 7, the random gene expression signal sets generated contain between about 25 and 50, or 28-32 or about 30 genes.

In an embodiment of the invention as described in the process above, in step 12 the top 26-50, or 28-32 or about 30 genes are selected.

In some cases when considering tumour characteristics relating to patient survival, it will be desirable to employ at least one cancer biomarker set selected from the list consisting essentially of NRC-1, NRC-2, NRC-3, NRC-4, NRC-5, NRC-6, NRC-7, NRC-8, and NRC-9.

In an embodiment of the invention there is provided a kit comprising at least three marker sets and instructions to carry out the process described above in order to identify a tumour characteristic of interest. In some cases, the kit will comprise at least 10 gene expression signals listed in Table 1A or 1 B. In some cases, the kit will comprise at least 30 nucleic acid biomarkers identified according to the process described above.

In an embodiment of the invention there is provided the use of any of the gene expression signals in Table 1A or 1B in identifying one or more tumour characteristics of interest. In some cases, at least different three markers sets are used in some cases at least 1, 2, or 3 of the marker sets including at least 1, 5, 10, 20, or 25 of the gene expression signals found in Table 1A or 1 B. In some cases each marker set contains at least 1, 5, 10, 20 or 25 of the gene expression signals found in Table 1A or 1 B.

In an embodiment of the invention, the cancer biomarkers are breast cancer biomarkers and the first subtype of sample is an ER+ sample.

In an embodiment of the invention, in the process described above, the random training sets are generated by randomly picking samples while maintaining the same ratio of “good” and “bad” tumours as that in the set from which they are chosen.

In some cases, the tumour characteristic(s) of interest will relate to patient survival (for example, following surgery and typical standard of care) and in such cases, the method may be used to identify patients in need of more or less aggressive treatment than the typical standard of care. (Chemotherapy and radiation treatment are, in themselves, hazardous. Thus, it is best to avoid providing such treatment to patients who do not need them.)

In some cases, it will be desirable to study tumour tissue for a patient by extracting gene expression signals (e.g. mRNA, protein) and assaying the presence (and in some cases level) of gene expression signals of interest using a reporter specific for the gene expression signal of interest. This may be done in a micro-array format permitting examination of multiple gene expression signals essentially simultaneously. A reporter may be a probe which binds to a nucleic acid sequence of interest, an antibody specific to a protein of interest, or any other such material (many such reporters are known in the art and used routinely). The reporter effects a change in the sample permitting assessment of the gene expression signal of interest. In some cases the change effected may be a change in an optical aspect of the sample, in other cases the change may be a change in another assayable aspect of the sample such as its radioactive or fluorescent properties.

In situations where a particular type of cancer has more than one subtype (eg. ER+ and ER− breast cancers), it will be preferable to classify the patient's cancer by subtype initially, and then use markers developed in relation to that subtype.

In some cases, the tumour characteristic(s) of interest will relate to tumour response to particular treatment(s) and in such cases, the method may be used to identify promising treatment approaches (one or more chemotherapeutics or combinations of treatments) for the patient having the tumour.

As used herein “tumour” includes any cancer cell which it is desirable to destroy or neutralize in a patient. For example, it may include cancer cells found in solid tumours, myelomas, lymphomas and leukemias.

Tumours will generally be mammalian or bird tumours and may be tumours of: human, ape, cat, dog, pig, cattle, sheep, goat, rabbit, mouse, rat, guinea pig, hamster, gerbil, chicken, duck, or goose.

It will be apparent that the combinatorial use of three independent sets of gene expression signals is not limited to gene expression signals produced according to the approach described herein, but may also be applied to cancer biomarker datasets sold commercially or reported in the literature. (Although the reliability of the final screening result will depend to some extend on the robustness of the sets used and therefore it is recommended to use cancer biomarker datasets which are robust). In some instances it will be desirable to select cancer biomarker datasets comprising genes involved in different biological processes (E.g. one dataset might relate to inflammation, another to cell cycle and the third to metastasis.)

The process is general and may be applied to any type of cancer. For example it is useful in relation to those cancer types listed in Table 4.

In an embodiment of the invention, the process is applied to determine how aggressively a breast cancer patient should be treated post-surgery.

One embodiment of the process is provided below, in parallel with a description of Example 1:
Step 1: developing an automatic survival screening method using cancer cell gene microarray data and survival information of the tumour patients. (By way of non-limiting example, surface and secreted proteins were identified from the microarray data of JM01 cell line (mouse breast cancer cell line, in-house cell line and data), to screen a public breast cancer dataset (295 samples, Chang et al., PNAS 102:3738, 2005). The term “survival screening” is defined as examination of the statistical significance of the correlation between each single gene expression value and patient survival status (“good” or “bad”) by performed Kaplan-Meier analysis by implementing the Cox-Mantel log-rank test (Cui et al., Molecular Systems Biology, 3:152, 2007). From this screening, seven proteins were obtained, which can individually distinguish ‘good’ and ‘bad’ tumours. By way of example, in a portion of Example 1, the protein (MMP9) was selected to be validated experimentally in the original cell line. When applying MMP9 antibody to the cell line, the epithelial to mesenchymal transition in cancer progression was blocked. This result indicates that the method is suitable to find metastasis related genes.
Step 2 conducting a genome-wide survival screening of genes whose expression values are correlated with breast cancer patient survivals was conducted. (In Example 1, two training datasets, defined as Dataset 1 (78 samples, van't Veer et al., Nature, 2002), and Dataset 2 (286 samples, Wang et al., Lancet, 365:671, 2005), were used.) The resulting gene expression signal lists are called S1, and S2, respectively. The total genes of these two lists are called St gene expression signal list (St=S1+S2).
Step 3: Where the cancer of interest has more than one sub-type, markers for a first sub-type are generated. (For example, in Example 1, ER+ and ER− markers were generated.) In Example 1, ER+ tumour markers were generated by extracting all the ER+ samples from above datasets and defined as S1-ER+ (extracted from Dataset 1) and S2-ER+ sets (extracted from Dataset 2), respectively. 35 random-training-sets are generated by randomly picking up N samples (N=60) from S2-ER+ sets. The ratio of “good” and “bad” tumours is preserved essentially the same as that in S2-ER+ sets. 36 training-sets are obtained by adding S1-ER+ to the 35 random-training-sets mentioned above.
Step 4: obtaining a gene expression signal list (in Example 1, St-ER+ gene expression signal list) by genome-wide survival screening, which involves repeating Step 2 but using subsets for the first tumour subtype, eg. datasets, S1-ER+ and S2-ER+ sets in Example 1. Using the St-ER+ gene expression signal list, Gene Ontology (GO) analysis (using GO annotation software, David, http://david.abcc.ncifcrf.gov/) is performed, only the genes which belong to GO terms that are known to be associated with cancer, such as cell cycle, cell death and so on are used for further marker screening.
Step 5: 1 million distinct random-gene-sets (each random-gene-set contains 30 genes) are generated from each selected GO term annotated genes (normally around 60-80 genes per GO term by randomly picking up 30 genes from one GO term annotated genes.
Steps 6 and 7: Further survival screening is conducted, preferably using 1 million random-gene-sets against all the first tumour subtype training sets (eg. In Example 1, 36 ER+ training sets) (generated in Step 3). For each training set, the statistical significance of the correlation between the expression values of each random-gene-set (30 genes) and patient survival status (“good” or “bad”) is examined, for example by performed Kaplan-Meier analysis by implementing the Cox-Mantel log-rank test. If the P value is less than 0.05 for a survival screening using one random-gene-set against one training set, it is said that that random-gene-set passed that training set.
Step 7: When all the first subtype (eg. 36 ER+) training sets have more than 2,000 random-gene-sets passed, or a P value of more than 0.05 has been obtained for more than 90% of the randon training datasets, these passed random-gene-sets are kept.
Step 8: The genes in the kept random-gene-sets of claim 7 are ranked based on the frequencies appearance in the passed random-gene-sets.
Step 9: The top 30 genes (defined as potential marker set) are chosen as a potential-marker-set. It should be noted that, while 30 genes are preferred, between 20 and 40 may be used, more preferably between 25 and 35 or more preferably 27-33. In some instances, 25-30 individual gene expression signals are desired in each set used for screening purposes, thus various input numbers may be used to produce this output.
Step 10: Step 5 is repeated using the same GO term used initially in Step 5 and another 1 million distinct random-gene-sets are generated, which are used to repeat Steps 6 and 7.
Step 11: If the gene members for the top 30 are substantially the same as those in the potential-marker-set (step 9), it means the potential-marker-set is stable and can be used as a real cancer biomarker set. This potential-marker-set is designated as a marker set (this one can be used for patients now), If the gene expression signals for the two potential marker sets are not substantially the same it is an indication that these GO term genes are unsuitable for finding a biomarker set and the potential marker sets are dropped from further analysis. In some cases it will be desirable to have at least 25 of the 30 gene expression signals the same in the two potential marker sets before designating it as a marker set. In some cases it will be desirable to have 26, 27, 28, 29, or 30 of the gene expression signals the same in the two potential marker sets.
Step 12: Steps 5-11 are repeated twice more for two other groups (of step 3) of gene expression signals. Thus, there will be three sets of stable signatures, each relating to a different group from step 3.
In example 1, 3 sets of markers (called NRC-1, -2 and -3, respectively, each set contains 30 genes, see Table 1) were obtained and tested in ER+training sets (S1-ER+ and S2-ER+). The testing process is illustrated. The samples in each training set can be divided into three groups: low-risk, intermediate-risk and high-risk groups.
   Optional step 12 b: as an optional step, which was carried out in Example 1, it can be useful to further analyze biomarker sets to further stratify the high-risk group. This step involves taking the samples from high-risk group (which in Example 1 was stratified by NRC-1, -2 and -3, of the training set, S2-ER+) and repeating Steps 3, 4, 5, 6, 7, and 8.
In Example 1, another 3 sets of markers (called NRC-4, -5 and -6, respectively were obtained. Each set contained 30 genes (see Table 1). These sets were targeted for the high-risk group which was stratified by NRC-1, -2 and -3.
   Step 12 c: as an optional step, conducted in Experiment 1, to get biomarkers for a second sub-type of tumours (in example 1,ER− tumours) all second subtype samples in datasets 1 and 2 are extracted (eg. the ER− samples from Datasets 1 and 2, respectively, and defined as S1-ER− (extracted from Dataset 1) and S2-ER− (extracted from Dataset 2) sets, respectively). 35 random-training-sets are generated by randomly picking up N samples (N=40) from dataset 2, subtype two sets (eg. S2-ER− sets). The ratio of “good” and “bad” tumours is maintained as that in the overall dataset 2, subtype 2 sets (S2-ER− sets). Training-sets are obtained (36 in Example 1) by adding dataset 1, type 2 (eg. S1-ER−) to the 35 random-training-sets mentioned above. Step 4 is repeated using dataset 1, subtype 2 (eg.S1-ER−) and dataset 2, subtype 2 (eg. S2-ER−) sets to obtain a combined dataset, subtype 2 (eg. St-ER−) gene expression signal list, and then GO analysis is performed. Steps 5, 6, 7, and 8 are then repeated.

In Example 1, another 3 sets of markers (called NRC-7, -8 and -9, respectively. Each set contains 30 genes, see Table 1) were obtained. These sets were used for ER− samples.

### Testing Process

### General Overview

### EXAMPLE 1

In example 1, for each marker set, nearest shrunken centroid classification and leave-one-out methods were employed. We then combinatory used 3 marker sets together for predicting the recurrence of each sample.

For a given dataset, which contains n samples, the test process used in Example 1 was the following (step by step):
Step 13: For a targeted testing sample, we extracted the gene expression profile of the marker set. For each gene expression value, we multiply its marker-factor and get the modified gene expression profile of the testing sample. We computed the standardized centroids for both “good” and “bad” classes from the n−1 samples for the marker set using PAM method (Tibshirani et al., PNAS, 99:6567, 2002). Multiply the marker-factor of each gene to the class centroids and get the modified class centroids of the marker set.

For predicting the recurrence of the targeted testing sample using the marker set: we compare the modified gene expression profile of the sample to each of these modified class centroids. The class whose centroid that it is closest to, in squared distance, is the predicted class for that sample. If the sample is predicted as “good” tumour, it is denoted as 0, otherwise, it is denoted as 1.
Step 14: For ER+ samples, if a sample has predicted as 0 for all 3 marker sets, we assign it in low-risk group; If a sample has predicted as 1 for all 3 marker sets, we assign it in a high-risk group; If a sample is not assigned in low-risk group neither high-risk group, we assign it in intermediate-risk group. For ER− samples, a sample has predicted as 0 for all 3 marker sets, we assign it into low-risk group, otherwise, we assign it into high-risk group. This is a modification of the usual practice of assigning ambiguous samples to an intermediate group. In the case of highly aggressive cancer subtypes, it may be desirable to classify all cancers which are not clearly low-risk as high risk and treat them aggressively, beyond the ordinary standard of care.

### Validation of the Marker Sets in Three Testing Datasets

To test the robustness and predicting accuracy of the marker sets, we tested the marker sets in three independent breast cancer datasets from these publications (Koe et al., Cancer Cell, 2006; Chang et al., PNAS 102:3738, 2005 and Sotiriou C, et al., J. Natl Cancer Inst, 98:262, 2006), In total, 644 samples were tested.

For ER+ samples, in each dataset, we first used NRC-1, -2 and -3 marker sets (from the three breast cancer datasets mentioned above) to stratify the samples into low (LG), intermediate (MG) and high (HG)-risk groups. If the high-risk group had less than 10 samples, we merged MG and HG groups and called it intermediate-risk group. Otherwise, we used NRC-4, -5 and -6 marker sets to stratify the HG group into three new groups: low (NLG), intermediate (NMG) and high (NHG)-risk groups. We merged NLG and MG and called it intermediate-risk group, and merged NMG and NHG and called it a high-risk group. The LG is low-risk group. We obtained very good results with high predictability accuracy (−90% for non-recurrence patients) for the low-risk group and classified three groups nicely in all the 3 testing datasets (See table 2).

For ER− samples, in each dataset, we used NRC-7, -8 and -9 marker sets to stratify the samples into low (LG-) and high (HG-)-risk groups. We also obtained very good results with high predicting accuracy (˜92-100% for non-recurrence patients) for the low-risk group and classified two groups nicely in all the 3 testing datasets (See table 2).

### Combinatory Usage of the Marker Sets Improve Predicting Accuracy

For ER+ samples, when NRC-1, NRC-2 and NRC-3 are all in agreement to predict the sample as “good” tumour, the accuracy was significantly improved than using a single marker set, such as NRC-1, NRC-2 or NRC-3 (Table 3). The same results were obtained when NRC-7, NRC-8 and NRC-9 are all in agreement to predict the sample as “good” tumour for ER− samples (Table 3). In general, it is found that the integrative usage of 3 marker sets improves predictive accuracy over using a single set. In one embodiment of the invention accuracy was improved from about 70% to about 90%. In one embodiment of the invention, accuracy is at least 90%. In another embodiment it is at lease 95%.

Thus, there is provided herein robust sets of biomarkers and uses thereof.

It will be understood that, depending on the type of cancer, and the condition of the patient, different gene profiles may be considered “bad”. Metastasis is generally considered to be a significant factor in the decision about how to treat a patient with cancer and sets of biomarker sets, such as those disclosed herein, are useful for that purpose. In addition, biomarker sets can be used to identify cancer cell types which are likely to respond well (or poorly) to one or more particular drugs. Regardless of the exact factors being considered as “good” or “bad”, it will usually be desirable to begin the process with training sets S1 and S2 containing both “good” and “bad” genes. Level of gene expression may be considered when identifying good drug targets since highly-expressed targets frequently make good drug targets.

In general, the low-risk group (having “good prognostic signature”) will not go to treatment, but high-risk group (having “poor prognostic signature”) should receive treatment in addition to surgery. Generally, the intermediate-risk group will do so as well; however, this will depend on the typical standard of care for that type of tumour.

While each of the biomarker sets disclosed herein is, individually, useful in predicting the need for additional treatment, overall prediction accuracy can be markedly improved by the use of multiple biomarker sets.

For example, if a patient sample is screened against NRC_{—}1, NRC_{—}2 and NRC_{—}3 and all three sets indicate “good” prognosis, the patient is considered to be low risk. If all indicate “bad” prognosis, the sample is considered to be high risk. If one or two sets say “bad” and the other(s) says “good”, the cancer is considered to be intermediate risk.

In an embodiment of the invention, in order to determine if a patient sample is “good” or “bad” in relation to any one biomarker set (e.g. NRC_{—}1), the biomarker set is used to independently screen two banks of cancer cells representing samples from a large number of patients. The first bank represents “good” cancer cells (with a known clinical history of not exhibiting the behaviour or characteristic of concern, such as metastasis) and the second bank represents “bad” cancer cells (with a known clinical history of exhibiting the behaviour or characteristic of concern). Each of the “good” and “bad” banks will produce a gene expression signature (standard “good” and “bad” gene expression signatures for “good” and “bad” tumours), respectively, for each biomarker set. For a patient sample, the gene expression signature of a biomarker set of the patient sample is compared to the standard “good” and “bad” gene expression signatures of that biomarker set. Those patient samples which most closely resemble the standard “bad” signature of that biomarker set are considered “bad” and those which most closely resemble the standard “good” signature of that biomarker set are considered “good.”

The method may in some cases involve the combinatory using of one or more of the following cancer biomarker sets: NRC-1, NRC-2, NRC-3, NRC-4, NRC-5, NRC-6, NRC-7, NRC-8, NRC-9.

Example of one possible approach to using the process when a subtype has been identified (for this example ER+/ER−)−:
ER status is determined for the tumour sample of cancer cells. (this is often done in clinical setting)
For ER+ samples, if a sample has predicted as “good” for all 3 marker sets (NRC-1, -2, and -3), it is assigned into low-risk group; If a sample has predicted as “bad” for all 3 marker sets, it is assigned into a high-risk group; If a sample is not assigned into low-risk group neither high-risk group, it is assigned into intermediate-risk group.
For the ER+ high-risk group, which is defined by the marker sets (NRC-1, -2, and -3), is predicted again using the marker sets (NRC-4, -5, and -6). If a sample has predicted as “bad” for all 3 marker sets, it is assigned into a high-risk group. Otherwise, it is assigned into the intermediate-risk group, which is defined by NRC-1, -2, and -3.
For ER− samples, a sample has predicted as “good” for all 3 marker sets (NRC-7, -8, and -9), it is assigned into low-risk group, otherwise, it is assigned into high-risk group.

In an embodiment of the invention there is provided a method of assessing the likelihood of a patient benefiting form additional cancer treatment in addition to surgery, said method comprising:
printing gene probes of the marker sets onto a microarray gene chip
extracting message RNAs from the tumour sample.
hybridizing the message RNA onto the microarray gene chip.
scanning the hybridized microarray chip to get all the readouts of marker genes for the sample.
normalizing the readouts
constructing the gene expression profiles of each marker set for the sample
correlating the gene expression profiles of each marker set to those of the standard (known as “good” and “bad”) tumour samples to make predictions.

Detailed information for making microarray gene chip, scanning and normalization of array data can be found at Agilent company website:

http://www.chem.agilent.com/en-US/products/instruments/dnamicroarrays/pages/default.aspx. and in the publicly available literature.

TABLE 1A
Lists of NRC biomarker gene signatures for ER+ and ER− breast cancer patients:

| | | |
|---|---|---|
| EntrezGene ID | Gene Name | Description |

NRC_1 (immune)

| | | |
|---|---|---|
| 730 | C7 | Complement component 7 |
| 6401 | SELE | Selectin E (endothelial adhesion molecule 1) |
| 939 | CD27 | CD27 molecule |
| 2152 | F3 | Coagulation factor III (thromboplastin, tissue factor) |
| 51561 | IL23A | Interleukin 23, alpha subunit p19 |
| 9607 | CARTPT | CART prepropeptide |
| 6696 | SPP1 | Secreted phosphoprotein 1 (osteopontin, bone sialoprot [symbol] |
| | | I, early T-lymphocyte activation 1) |
| 7138 | TNNT1 | Troponin T type 1 (skeletal, slow) |
| 784 | CACNB3 | Calcium channel, voltage-dependent, beta 3 subunit |
| 729 | C6 | Complement component 6 |
| 2165 | F13B | Coagulation factor XIII, B polypeptide |
| 6403 | SELP | Selectin P (granule membrane protein 140 kDa, antigen |
| | | CD62) |
| 5452 | POU2F2 | POU class 2 homeobox 2 |
| 6774 | STAT3 | Signal transducer and activator of transcription 3 (acute- |
| | | phase response factor) |
| 5265 | SERPINA1 | Serpin peptidase inhibitor, clade A (alpha-1 antiproteina [symbol] |
| | | antitrypsin), member 1 |
| 8074 | FGF23 | Fibroblast growth factor 23 |
| 4607 | MYBPC3 | Myosin binding protein C, cardiac |
| 7940 | LST1 | Leukocyte specific transcript 1 |
| 3952 | LEP | Leptin (obesity homolog, mouse) |
| 6776 | STAT5A | Signal transducer and activator of transcription 5A |
| 259 | AMBP | Alpha-1-microglobulin/bikunin precursor |
| 7125 | TNNC2 | Troponin C type 2 (fast) |
| 6331 | SCN5A | Sodium channel, voltage-gated, type V, alpha subunit |
| 857 | CAV1 | Caveolin 1, caveolae protein, 22 kDa |
| 5936 | RBM4 | RNA binding motif protein 4 |
| 641 | BLM | Bloom syndrome |
| 2534 | FYN | FYN oncogene related to SRC, FGR, YES |
| 604 | BCL6 | B-cell CLL/lymphoma 6 (zinc finger protein 51) |
| 10874 | NMU | Neuromedin U |
| 3240 | HP | Haptoglobin |

NRC_2 (cell cycle)

| | | |
|---|---|---|
| 5933 | RBL1 | Retinoblastoma-like 1 (p107) |
| 6790 | AURKA | Aurora kinase A |
| 898 | CCNE1 | Cyclin E1 |
| 332 | BIRC5 | Baculoviral IAP repeat-containing 5 (survivin) |
| 4830 | NME1 | Non-metastatic cells 1, protein (NM23A) expressed in |
| 259266 | ASPM | Asp (abnormal spindle) homolog, microcephaly associat |
| | | (Drosophila) |
| 3070 | HELLS | Helicase, lymphoid-specific |
| 10628 | TXNIP | Thioredoxin interacting protein |
| 3981 | LIG4 | Ligase IV, DNA, ATP-dependent |
| 10051 | SMC4 | Structural maintenance of chromosomes 4 |
| 4175 | MCM6 | Minichromosome maintenance complex component 6 |
| 1063 | CENPF | Centromere protein F, 350/400ka (mitosin) |
| 11186 | RASSF1 | Ras association (RalGDS/AF-6) domain family 1 |
| 51053 | GMNN | Geminin, DNA replication inhibitor |
| 9787 | DLG7 | Discs, large homolog 7 (Drosophila) |
| 11145 | HRASLS3 | HRAS-like suppressor 3 |
| 274 | BIN1 | Bridging integrator 1 |
| 4013 | LOH11CR2A | Loss of heterozygosity, 11, chromosomal region 2, gene |
| 5501 | PPP1CC | Protein phosphatase 1, catalytic subunit, gamma isoforn |
| 8099 | CDK2AP1 | CDK2-associated protein 1 |
| 10615 | SPAG5 | Sperm associated antigen 5 |
| 4750 | NEK1 | NIMA (never in mitosis gene a)-related kinase 1 |
| 22924 | MAPRE3 | Microtubule-associated protein, RP/EB family, member; |
| 1163 | CKS1B | CDC28 protein kinase regulatory subunit 1B |
| 5598 | MAPK7 | Mitogen-activated protein kinase 7 |
| 26060 | APPL1 | Adaptor protein, phosphotyrosine interaction, PH domai [symbol] |
| | | and leucine zipper containing 1 |
| 11011 | TLK2 | Tousled-like kinase 2 |
| 22933 | SIRT2 | Sirtuin (silent mating type information regulation 2 |
| | | homolog) 2 (S. cerevisiae) |
| 22919 | MAPRE1 | Microtubule-associated protein, RP/EB family, member |
| 5884 | RAD17 | RAD17 homolog (S. pombe) |

NRC_3 (apoptosis)

| | | |
|---|---|---|
| 4982 | TNFRSF11B | Tumour necrosis factor receptor superfamily, member 1 |
| | | (osteoprotegerin) |
| 7704 | ZBTB16 | Zinc finger and BTB domain containing 16 |
| 333 | APLP1 | Amyloid beta (A4) precursor-like protein 1 |
| 27250 | PDCD4 | Programmed cell death 4 (neoplastic transformation |
| | | inhibitor) |
| 9459 | ARHGEF6 | Rac/Cdc42 guanine nucleotide exchange factor (GEF) 6 |
| 8835 | SOCS2 | Suppressor of cytokine signaling 2 |
| 332 | BIRC5 | Baculoviral IAP repeat-containing 5 (survivin) |
| 983 | CDC2 | Cell division cycle 2, G1 to S and G2 to M |
| 9700 | ESPL1 | Extra spindle pole bodies homolog 1 (S. cerevisiae) |
| 7262 | PHLDA2 | Pleckstrin homology-like domain, family A, member 2 |
| 26586 | CKAP2 | Cytoskeleton associated protein 2 |
| 9135 | RABEP1 | Rabaptin, RAB GTPase binding effector protein 1 |
| 4893 | NRAS | Neuroblastoma RAS viral (v-ras) oncogene homolog |
| 4830 | NME1 | Non-metastatic cells 1, protein (NM23A) expressed in |
| 1191 | CLU | Clusterin |
| 6776 | STAT5A | Signal transducer and activator of transcription 5A |
| 596 | BCL2 | B-cell CLL/lymphoma 2 |
| 54205 | CYCS | Cytochrome c, somatic |
| 3605 | IL17A | Interleukin 17A |
| 4255 | MGMT | O-6-methylguanine-DNA methyltransferase |
| 10553 | HTATIP2 | HIV-1 Tat interactive protein 2, 30 kDa |
| 55367 | LRDD | Leucine-rich repeats and death domain containing |
| 1434 | CSE1L | CSE1 chromosome segregation 1-like (yeast) |
| 3981 | LIG4 | Ligase IV, DNA, ATP-dependent |
| 8717 | TRADD | TNFRSF1A-associated via death domain |
| 694 | BTG1 | B-cell translocation gene 1, anti-proliferative |
| 2730 | GCLM | Glutamate-cysteine ligase, modifier subunit |
| 4790 | NFKB1 | Nuclear factor of kappa light polypeptide gene enhancer |
| | | B-cells 1 (p105) |
| 5519 | PPP2R1B | Protein phosphatase 2 (formerly 2A), regulatory subunit |
| | | beta isoform |
| 5618 | PRLR | Prolactin receptor |

NRC_4 (cell motility)

| | | |
|---|---|---|
| 57045 | TWSG1 | Twisted gastrulation homolog 1 (Drosophila) |
| 3730 | KAL1 | Kallmann syndrome 1 sequence |
| 283 | ANG | Angiogenin, ribonuclease, RNase A family, 5 |
| 2549 | GAB1 | GRB2-associated binding protein 1 |
| 6352 | CCL5 | Chemokine (C-C motif) ligand 5 |
| 6402 | SELL | Selectin L (lymphocyte adhesion molecule 1) |
| 643 | BLR1 | Burkitt lymphoma receptor 1, GTP binding protein |
| | | (chemokine (C—X—C motif) receptor 5) |
| 3576 | IL8 | Interleukin 8 |
| 9542 | NRG2 | Neuregulin 2 |
| 6662 | SOX9 | SRY (sex determining region Y)-box 9 (campomelic |
| | | dysplasia, autosomal sex-reversal) |
| 9027 | NAT8 | N-acetyltransferase 8 |
| 7852 | CXCR4 | Chemokine (C—X—C motif) receptor 4 |
| 55591 | VEZT | Vezatin, adherens junctions transmembrane protein |
| 55704 | CCDC88A | Coiled-coil domain containing 88A |
| 2028 | ENPEP | Glutamyl aminopeptidase (aminopeptidase A) |
| 3912 | LAMB1 | Laminin, beta 1 |
| 2304 | FOXE1 | Forkhead box E1 (thyroid transcription factor 2) |
| 7059 | THBS3 | Thrombospondin 3 |
| 3915 | LAMC1 | Laminin, gamma 1 (formerly LAMB2) |
| 7043 | TGFB3 | Transforming growth factor, beta 3 |
| 23129 | PLXND1 | Plexin D1 |
| 8611 | PPAP2A | Phosphatidic acid phosphatase type 2A |
| 5921 | RASA1 | RAS p21 protein activator (GTPase activating protein) 1 |
| 6376 | CX3CL1 | Chemokine (C—X3—C motif) ligand 1 |
| 3087 | HHEX | Hematopoietically expressed homeobox |
| 9464 | HAND2 | Heart and neural crest derivatives expressed 2 |
| 4991 | OR1D2 | Olfactory receptor, family 1, subfamily D, member 2 |
| 6885 | MAP3K7 | Mitogen-activated protein kinase kinase kinase 7 |
| 7019 | TFAM | Transcription factor A, mitochondrial |
| 4692 | NDN | Necdin homolog (mouse) |

NRC_5 (cell proliferation)

| | | |
|---|---|---|
| 283 | ANG | Angiogenin, ribonuclease, RNase A family, 5 |
| 2919 | CXCL1 | Chemokine (C—X—C motif) ligand 1 (melanoma growth |
| | | stimulating activity, alpha) |
| 2549 | GAB1 | GRB2-associated binding protein 1 |
| 3507 | IGHM | |
| 7045 | TGFBI | Transforming growth factor, beta-induced, 68 kDa |
| 3576 | IL8 | Interleukin 8 |
| 973 | CD79A | CD79a molecule, immunoglobulin-associated alpha |
| 10220 | GDF11 | Growth differentiation factor 11 |
| 6662 | SOX9 | SRY (sex determining region Y)-box 9 (campomelic |
| | | dysplasia, autosomal sex-reversal) |
| 1032 | CDKN2D | Cyclin-dependent kinase inhibitor 2D (p19, inhibits CDK [symbol] |
| 11040 | PIM2 | Pim-2 oncogene |
| 10428 | CFDP1 | Craniofacial development protein 1 |
| 3600 | IL15 | Interleukin 15 |
| 5473 | PPBP | Pro-platelet basic protein (chemokine (C—X—C motif) liga [symbol] |
| | | 7) |
| 8451 | CUL4A | Cullin 4A |
| 5376 | PMP22 | Peripheral myelin protein 22 |
| 50810 | HDGFRP3 | Hepatoma-derived growth factor, related protein 3 |
| 4067 | LYN | V-yes-1 Yamaguchi sarcoma viral related oncogene |
| | | homolog |
| 7188 | TRAF5 | TNF receptor-associated factor 5 |
| 7453 | WARS | Tryptophanyl-tRNA synthetase |
| 3601 | IL15RA | Interleukin 15 receptor, alpha |
| 2028 | ENPEP | Glutamyl aminopeptidase (aminopeptidase A) |
| 5511 | PPP1R8 | Protein phosphatase 1, regulatory (inhibitor) subunit 8 |
| 55704 | CCDC88A | Coiled-coil domain containing 88A |
| 7041 | TGFB1I1 | Transforming growth factor beta 1 induced transcript 1 |
| 706 | TSPO | Translocator protein (18 kDa) |
| 8611 | PPAP2A | Phosphatidic acid phosphatase type 2A |
| 8850 | PCAF | P300/CBP-associated factor |
| 8914 | TIMELESS | Timeless homolog (Drosophila) |
| 23705 | CADM1 | Cell adhesion molecule 1 |

NRC_6 (sex)

| | | |
|---|---|---|
| 939 | CD27 | CD27 molecule |
| 5680 | PSG11 | Pregnancy specific beta-1-glycoprotein 11 |
| 283 | ANG | Angiogenin, ribonuclease, RNase A family, 5 |
| 6662 | SOX9 | SRY (sex determining region Y)-box 9 (campomelic |
| | | dysplasia, autosomal sex-reversal) |
| 6715 | SRD5A1 | Steroid-5-alpha-reductase, alpha polypeptide 1 (3-oxo-5 |
| | | alpha-steroid delta 4-dehydrogenase alpha 1) |
| 8863 | PER3 | Period homolog 3 (Drosophila) |
| 3620 | INDO | Indoleamine-pyrrole 2,3 dioxygenase |
| 668 | FOXL2 | Forkhead box L2 |
| 5079 | PAX5 | Paired box 5 |
| 23198 | PSME4 | Proteasome (prosome, macropain) activator subunit 4 |
| 54466 | SPIN2A | Spindlin family, member 2A |
| 7852 | CXCR4 | Chemokine (C—X—C motif) receptor 4 |
| 6347 | CCL2 | Chemokine (C-C motif) ligand 2 |
| 5818 | PVRL1 | Poliovirus receptor-related 1 (herpesvirus entry mediato [symbol] |
| 3576 | IL8 | Interleukin 8 |
| 4986 | OPRK1 | Opioid receptor, kappa 1 |
| 7707 | ZNF148 | Zinc finger protein 148 |
| 10670 | RRAGA | Ras-related GTP binding A |
| 1816 | DRD5 | Dopamine receptor D5 |
| 83737 | ITCH | Itchy homolog E3 ubiquitin protein ligase (mouse) |
| 1984 | EIF5A | Eukaryotic translation initiation factor 5A |
| 3416 | IDE | Insulin-degrading enzyme |
| 4184 | SMCP | Sperm mitochondria-associated cysteine-rich protein |
| 1628 | DBP | D site of albumin promoter (albumin D-box) binding prot [symbol] |
| 3295 | HSD17B4 | Hydroxysteroid (17-beta) dehydrogenase 4 |
| 8239 | USP9X | Ubiquitin specific peptidase 9, X-linked |
| 51665 | ASB1 | Ankyrin repeat and SOCS box-containing 1 |
| 3014 | H2AFX | H2A histone family, member X |
| 3624 | INHBA | Inhibin, beta A |
| 6019 | RLN2 | Relaxin 2 |

NRC_7 (apoptosis)

| | | |
|---|---|---|
| 1012 | CDH13 | Cadherin 13, H-cadherin (heart) |
| 57823 | SLAMF7 | SLAM family member 7 |
| 51129 | ANGPTL4 | Angiopoietin-like 4 |
| 23213 | SULF1 | Sulfatase 1 |
| 2697 | GJA1 | Gap junction protein, alpha 1, 43 kDa |
| 4583 | MUC2 | Mucin 2, oligomeric mucus/gel-forming |
| 3304 | HSPA1B | Heat shock 70 kDa protein 1B |
| 79370 | BCL2L14 | BCL2-like 14 (apoptosis facilitator) |
| 9994 | CASP8AP2 | CASP8 associated protein 2 |
| 2185 | PTK2B | PTK2B protein tyrosine kinase 2 beta |
| 3981 | LIG4 | Ligase IV, DNA, ATP-dependent |
| 2765 | GML | GPI anchored molecule like protein |
| 27250 | PDCD4 | Programmed cell death 4 (neoplastic transformation |
| | | inhibitor) |
| 28986 | MAGEH1 | Melanoma antigen family H, 1 |
| 355 | FAS | Fas (TNF receptor superfamily, member 6) |
| 308 | ANXA5 | Annexin A5 |
| 2914 | GRM4 | Glutamate receptor, metabotropic 4 |
| 57099 | AVEN | Apoptosis, caspase activation inhibitor |
| 842 | CASP9 | Caspase 9, apoptosis-related cysteine peptidase |
| 1409 | CRYAA | Crystallin, alpha A |
| 4792 | NFKBIA | Nuclear factor of kappa light polypeptide gene enhancer |
| | | B-cells inhibitor, alpha |
| 6788 | STK3 | Serine/threonine kinase 3 (STE20 homolog, yeast) |
| 5516 | PPP2CB | Protein phosphatase 2 (formerly 2A), catalytic subunit, b |
| | | isoform |
| 57019 | CIAPIN1 | Cytokine induced apoptosis inhibitor 1 |
| 8682 | PEA15 | Phosphoprotein enriched in astrocytes 15 |
| 7042 | TGFB2 | Transforming growth factor, beta 2 |
| 1870 | E2F2 | E2F transcription factor 2 |
| 2898 | GRIK2 | Glutamate receptor, ionotropic, kainate 2 |
| 972 | CD74 | CD74 molecule, major histocompatibility complex, class |
| | | invariant chain |
| 7189 | TRAF6 | TNF receptor-associated factor 6 |

NRC_8 (cell adhesion)

| | | |
|---|---|---|
| 57823 | SLAMF7 | SLAM family member 7 |
| 1012 | CDH13 | Cadherin 13, H-cadherin (heart) |
| 3547 | IGSF1 | Immunoglobulin superfamily, member 1 |
| 7045 | TGFBI | Transforming growth factor, beta-induced, 68 kDa |
| 1404 | HAPLN1 | Hyaluronan and proteoglycan link protein 1 |
| 80144 | FRAS1 | Fraser syndrome 1 |
| 10666 | CD226 | CD226 molecule |
| 26032 | SUSD5 | Sushi domain containing 5 |
| 10979 | PLEKHC1 | Pleckstrin homology domain containing, family C (with |
| | | FERM domain) member 1 |
| 9620 | CELSR1 | Cadherin, EGF LAG seven-pass G-type receptor 1 |
| | | (flamingo homolog, Drosophila) |
| 4815 | NINJ2 | Ninjurin 2 |
| 3684 | ITGAM | Integrin, alpha M (complement component 3 receptor 3 |
| | | subunit) |
| 2909 | GRLF1 | Glucocorticoid receptor DNA binding factor 1 |
| 54798 | DCHS2 | Dachsous 2 (Drosophila) |
| 2811 | GP1BA | Glycoprotein Ib (platelet), alpha polypeptide |
| 7414 | VCL | Vinculin |
| 6404 | SELPLG | Selectin P ligand |
| 2185 | PTK2B | PTK2B protein tyrosine kinase 2 beta |
| 4771 | NF2 | Neurofibromin 2 (bilateral acoustic neuroma) |
| 950 | SCARB2 | Scavenger receptor class B, member 2 |
| 101 | ADAM8 | ADAM metallopeptidase domain 8 |
| 3491 | CYR61 | Cysteine-rich, angiogenic inducer, 61 |
| 22795 | NID2 | Nidogen 2 (osteonidogen) |
| 55591 | VEZT | Vezatin, adherens junctions transmembrane protein |
| 4586 | MUC5AC | Mucin 5AC, oligomeric mucus/gel-forming |
| 3636 | INPPL1 | Inositol polyphosphate phosphatase-like 1 |
| 2833 | CXCR3 | Chemokine (C—X—C motif) receptor 3 |
| 261734 | NPHP4 | Nephronophthisis 4 |
| 10418 | SPON1 | Spondin 1, extracellular matrix protein |
| 8500 | PPFIA1 | Protein tyrosine phosphatase, receptor type, f polypepti [symbol] |
| | | (PTPRF), interacting protein (liprin), alpha 1 |

NRC_9 (cell growth)

| | | |
|---|---|---|
| 23418 | CRB1 | Crumbs homolog 1 (Drosophila) |
| 3488 | IGFBP5 | Insulin-like growth factor binding protein 5 |
| 2620 | GAS2 | |
| 5654 | HTRA1 | HtrA serine peptidase 1 |
| 27113 | BBC3 | BCL2 binding component 3 |
| 2697 | GJA1 | Gap junction protein, alpha 1, 43 kDa |
| 348 | APOE | Apolipoprotein E |
| 4881 | NPR1 | Natriuretic peptide receptor A/guanylate cyclase A |
| | | (atrionatriuretic peptide receptor A) |
| 575 | BAI1 | Brain-specific angiogenesis inhibitor 1 |
| 9837 | GINS1 | GINS complex subunit 1 (Psf1 homolog) |
| 51466 | EVL | Enah/Vasp-like |
| 357 | SHROOM2 | Shroom family member 2 |
| 207 | AKT1 | V-akt murine thymoma viral oncogene homolog 1 |
| 2027 | ENO3 | Enolase 3 (beta, muscle) |
| 6531 | SLC6A3 | Solute carrier family 6 (neurotransmitter transporter, |
| | | dopamine), member 3 |
| 8089 | YEATS4 | YEATS domain containing 4 |
| 6905 | TBCE | Tubulin folding cofactor E |
| 3490 | IGFBP7 | Insulin-like growth factor binding protein 7 |
| 6665 | SOX15 | SRY (sex determining region Y)-box 15 |
| 55785 | FGD6 | FYVE, RhoGEF and PH domain containing 6 |
| 5925 | RB1 | Retinoblastoma 1 (including osteosarcoma) |
| 55558 | PLXNA3 | Plexin A3 |
| 7251 | TSG101 | Tumour susceptibility gene 101 |
| 978 | CDA | Cytidine deaminase |
| 3912 | LAMB1 | Laminin, beta 1 |
| 7042 | TGFB2 | Transforming growth factor, beta 2 |
| 56288 | PARD3 | Par-3 partitioning defective 3 homolog (C. elegans) |
| 7486 | WRN | Werner syndrome |
| 2054 | STX2 | Syntaxin 2 |
| 5516 | PPP2CB | Protein phosphatase 2 (formerly 2A), catalytic subunit, b |
| | | isoform |

Note:
The message RNA sequences for each gene listed in this table have been attached at the end of this document. All message RNA sequences for each gene in Table 1 are extracted from National Center for Biotechnology Information (NCBI), a public database. [symbol]
indicates data missing or illegible when filed

The format of sequences is a FASTA format. A sequence in FASTA format begins with a single-line description, followed by lines of sequence data. The description line is distinguished from the sequence data by a greater-than (“>”) symbol in the first column.

An example sequence in FASTA:

>6019|NM_005059
ATGCCTCGCCTGTTTTTTTTCCACCTGCTAGGAGTCTGTTTACTACTGAACCAATTTTCCAGAGCAGTCG
CGGACTCATGGATGGAGGAAGTTATTAAATTATGCGGCCGCGAATTAGTTCGCGCGCAGATTGCCATTTG
CGGCATGAGCACCTGGAGCAAAAGGTCTCTGAGCCAGGAAGATGCTCCTCAGACACCTAGACCAGTGGCA
GGTGATTTTATTCAAACAGTCTCACTGGGAATCTCACCGGACGGAGGGAAAGCACTGAGAACAGGAAGCT
GCTTCACCCGAGAGTTCCTTGGTGCCCTTTCCAAATTGTGCCATCCTTCATCAACAAAGATACAGAAACC
ATAAATATGATGTCAGAATTTGTTGCTAATTTGCCACAGGAGCTGAAGTTAACCCTGTCTGAGATGCAGC
CAGCATTACCACAGCTACAACAACATGTACCTGTATTAAAAGATTCCAGTCTTCTCTTTGAAGAATTTAA
GAAACTTATTCGCAATAGACAAAGTGAAGCCGCAGACAGCAGTCCTTCAGAATTAAAATACTTAGGCTTG
GATACTCATTCTCGAAAAAAGAGACAACTCTACAGTGCATTGGCTAATAAATGTTGCCATGTTGGTTGTA
CCAAAAGATCTCTTGCTAGATTTTGCTGAGATGAAGCTAATTGTGCACATCTCGTATAATATTCACACAT
ATTCTTAATGACATTTCACTGATGCTTCTATCAGGTCCCATCAATTCTTAGAATATCTAAGAATCTTTGT
TAGATATTAGGTCCCATCAATTCTTAGAATATCTAAACATCTTTGTTGATGTTTAGATTTTTTTATTTGA
TGTGTAAGAAAATGTTCTTTGTGTGATTAAATGACACATTTTTTTGCTG

In the description line, the first item, 6019 is NCBI EntrezGene ID, which is the ID in the first column of Table 1; another item after the symbol (“|”) is the NCBI reference message RNA sequence ID. It should be noted that one EntrezGene ID may have several reference message RNA sequences. In this case, all the message RNA sequences for one EntrezGene ID are listed. Each sequence represents one reference message RNA sequence.

TABLE 1B
Gene expression signal list of NRC gene signatures

| | | |
|---|---|---|
| Gene Name | EntrezGene ID | Gene Description |

NRC-1 (Cell Cycle)

| | | |
|---|---|---|
| RBL1 | 5933 | Retinoblastoma-like 1 (p107) |
| CCNF | 899 | Cyclin F |
| NME1 | 4830 | Non-metastatic cells 1, protein (NM23A) expressed |
| | | in |
| CDK2AP1 | 8099 | CDK2-associated protein 1 |
| BIRC5 | 332 | Baculoviral IAP repeat-containing 5 (survivin) |
| TLK2 | 11011 | Tousled-like kinase 2 |
| SMC4 | 10051 | Structural maintenance of chromosomes 4 |
| CCNE1 | 898 | Cyclin |
| | | E1 |
| APPL1 | 26060 | Adaptor protein, phosphotyrosine interaction, PH domain and leucine zipper |
| LOH11CR2A | 4013 | Loss of heterozygosity, 11, chromosomal region 2, gene A |
| MAPRE1 | 22919 | Microtubule-associated protein, RP/EB family, member 1 |
| HRASLS3 | 11145 | HRAS-like suppressor 3 |
| GADD45A | 1647 | Growth arrest and DNA-damage-inducible, alpha |
| HELLS | 3070 | Helicase, lymphoid-specific |
| PPP1CC | 5501 | Protein phosphatase 1, catalytic subunit, gamma isoform |
| GMNN | 51053 | Geminin, DNA replication inhibitor |
| EPHB2 | 2048 | EPH receptor B2 |
| RAD17 | 5884 | RAD17 homolog (S. pombe) |
| AURKA | 6790 | Aurora kinase A |
| NEK1 | 4750 | NIMA (never in mitosis gene a)-related kinase 1 |
| RASSF1 | 11186 | Ras association (RalGDS/AF-6) domain family 1 |
| VASH1 | 22846 | Vasohibin 1 |
| MAPRE3 | 22924 | Microtubule-associated protein, RP/EB family, member 3 |
| CDCA8 | 55143 | Cell division cycle associated 8 |
| CDC73 | 79577 | Cell division cycle 73, Paf1/RNA polymerase II complex component, homolo [symbol] |
| SIRT2 | 22933 | Sirtuin (silent mating type information regulation 2 homolog) 2 (S. cerevisiae) |
| MAPK7 | 5598 | Mitogen-activated protein kinase 7 |
| MKI67 | 4288 | Antigen identified by monoclonal antibody Ki-67 |
| TFDP1 | 7027 | Transcription factor Dp-1 |
| DMBT1 | 1755 | Deleted in malignant brain tumours 1 |

NRC-2(immune)

| | | |
|---|---|---|
| C7 | 730 | Complement component 7 |
| SELE | 6401 | Selectin E (endothelial adhesion molecule 1) |
| CD27 | 939 | CD27 molecule |
| F3 | 2152 | Coagulation factor III (thromboplastin, tissue factor) |
| IL23A | 51561 | Interleukin 23, alpha subunit |
| | | p19 |
| CARTPT | 9607 | CART |
| | | prepropeptide |
| SPP1 | 6696 | Secreted phosphoprotein 1 (osteopontin, bone sialoprotein I, early T-lymphc [symbol] |
| TNNT1 | 7138 | Troponin T type 1 (skeletal, slow) |
| CACNB3 | 784 | Calcium channel, voltage-dependent, beta 3 subunit |
| C6 | 729 | Complement component 6 |
| F13B | 2165 | Coagulation factor XIII, B polypeptide |
| SELP | 6403 | Selectin P (granule membrane protein 140 kDa, antigen CD62) |
| POU2F2 | 5452 | POU class 2 homeobox 2 |
| STAT3 | 6774 | Signal transducer and activator of transcription 3 (acute-phase response fac [symbol] |
| SERPINA1 | 5265 | Serpin peptidase inhibitor, clade A (alpha-1 antiproteinase, antitrypsin), men [symbol] |
| FGF23 | 8074 | Fibroblast growth factor 23 |
| MYBPC3 | 4607 | Myosin binding protein C, cardiac |
| LST1 | 7940 | Leukocyte specific transcript 1 |
| LEP | 3952 | Leptin (obesity homolog, mouse) |
| STAT5A | 6776 | Signal transducer and activator of transcription 5A |
| AMBP | 259 | Alpha-1-microglobulin/bikunin precursor |
| TNNC2 | 7125 | Troponin C type 2 (fast) |
| SCN5A | 6331 | Sodium channel, voltage-gated, type V, alpha |
| | | subunit |
| CAV1 | 857 | Caveolin 1, caveolae protein, 22 kDa |
| RBM4 | 5936 | RNA binding motif protein 4 |
| BLM | 641 | Bloom syndrome |
| FYN | 2534 | FYN oncogene related to SRC, FGR, |
| | | YES |
| BCL6 | 604 | B-cell CLL/lymphoma 6 (zinc finger protein 51) |
| NMU | 10874 | Neuromedin U |
| HP | 3240 | Haptoglobin |

NRC-3 (apoptosis)

| | | |
|---|---|---|
| ZBTB16 | 7704 | Zinc finger and BTB domain containing 16 |
| ARHGEF6 | 9459 | Rac/Cdc42 guanine nucleotide exchange factor (GEF) 6 |
| PHLDA2 | 7262 | Pleckstrin homology-like domain, family A, member 2 |
| TNFRSF11B | 4982 | Tumour necrosis factor receptor superfamily, member 11b |
| | | (osteoprotegerin) |
| CYCS | 54205 | Cytochrome c, somatic |
| TRADD | 8717 | TNFRSF1A-associated via death domain |
| BIRC5 | 332 | Baculoviral IAP repeat-containing 5 (survivin) |
| PDCD4 | 27250 | Programmed cell death 4 (neoplastic transformation inhibitor) |
| SOCS2 | 8835 | Suppressor of cytokine signaling 2 |
| PPP2R1B | 5519 | Protein phosphatase 2 (formerly 2A), regulatory subunit A, beta isoform |
| MGMT | 4255 | O-6-methylguanine-DNA |
| | | methyltransferase |
| IKBKG | 8517 | Inhibitor of kappa light polypeptide gene enhancer in B-cells, kinase |
| | | gamma |
| BTG1 | 694 | B-cell translocation gene 1, anti- |
| | | proliferative |
| NRAS | 4893 | Neuroblastoma RAS viral (v-ras) oncogene homolog |
| ESPL1 | 9700 | Extra spindle pole bodies homolog 1 (S. cerevisiae) |
| CDC2 | 983 | Cell division cycle 2, G1 to S and G2 to M |
| APLP1 | 333 | Amyloid beta (A4) precursor-like protein 1 |
| TCTN3 | 26123 | Tectonic family member 3 |
| NME1 | 4830 | Non-metastatic cells 1, protein (NM23A) expressed |
| | | in |
| STAT5A | 6776 | Signal transducer and activator of transcription 5A |
| CLU | 1191 | Clusterin |
| BCL2 | 596 | B-cell CLL/lymphoma 2 |
| HTATIP2 | 10553 | HIV-1 Tat interactive protein 2, 30 kDa |
| EEF1A2 | 1917 | Eukaryotic translation elongation factor 1 alpha 2 |
| INHA | 3623 | Inhibin, alpha |
| TNFSF9 | 8744 | Tumour necrosis factor (ligand) superfamily, member 9 |
| LRDD | 55367 | Leucine-rich repeats and death domain containing |
| FADD | 8772 | Fas (TNFRSF6)-associated via death domain |
| IL19 | 29949 | Interleukin 19 |
| KIAA0367 | 23273 | |

NRC_4 (cell adhesion)

| | | |
|---|---|---|
| CHL1 | 10752 | Cell adhesion molecule with homology to L1CAM (close homolog of L1) |
| COL15A1 | 1306 | Collagen, type XV, alpha 1 |
| CRNN | 49860 | Cornulin |
| KAL1 | 3730 | Kallmann syndrome 1 |
| | | sequence |
| SOX9 | 6662 | SRY (sex determining region Y)-box 9 (campomelic dysplasia, autosomal s [symbol] |
| | | reversal) |
| PTPRF | 5792 | Protein tyrosine phosphatase, receptor type, F |
| ITGA7 | 3679 | Integrin, alpha 7 |
| MFAP4 | 4239 | Microfibrillar-associated protein 4 |
| EDG1 | 1901 | Endothelial differentiation, sphingolipid G-protein-coupled receptor, 1 |
| ZEB2 | 9839 | Zinc finger E-box binding homeobox 2 |
| PDZD2 | 23037 | PDZ domain containing 2 |
| ROBO1 | 6091 | Roundabout, axon guidance receptor, homolog 1 (Drosophila) |
| FBN2 | 2201 | Fibrillin 2 (congenital contractural arachnodactyly) |
| POSTN | 10631 | Periostin, osteoblast specific factor |
| CDH5 | 1003 | Cadherin 5, type 2, VE-cadherin (vascular |
| | | epithelium) |
| PKD1 | 5310 | Polycystic kidney disease 1 (autosomal dominant) |
| TGFB1I1 | 7041 | Transforming growth factor beta 1 induced transcript 1 |
| ITGA5 | 3678 | Integrin, alpha 5 (fibronectin receptor, alpha polypeptide) |
| RASA1 | 5921 | RAS p21 protein activator (GTPase activating protein) 1 |
| COL11A2 | 1302 | Collagen, type XI, alpha 2 |
| VEZT | 55591 | Vezatin, adherens junctions transmembrane protein |
| CLDN4 | 1364 | Claudin 4 |
| BCL6 | 604 | B-cell CLL/lymphoma 6 (zinc finger protein 51) |
| AMIGO2 | 347902 | Adhesion molecule with Ig-like domain 2 |
| ECM2 | 1842 | Extracellular matrix protein 2, female organ and adipocyte specific |
| FAF1 | 11124 | Fas (TNFRSF6) associated factor 1 |
| ITGB8 | 3696 | Integrin, beta 8 |
| PRPH2 | 5961 | Peripherin 2 (retinal degeneration, slow) |
| CEACAM1 | 634 | Carcinoembryonic antigen-related cell adhesion molecule 1 (biliary glycopro |
| THY1 | 7070 | Thy-1 cell surface antigen |

NRC_5 (cell cycle)

| | | |
|---|---|---|
| NDN | 4692 | Necdin homolog (mouse) |
| CDCA8 | 55143 | Cell division cycle associated 8 |
| CHEK2 | 11200 | CHK2 checkpoint homolog (S. pombe) |
| CDC45L | 8318 | CDC45 cell division cycle 45-like (S. cerevisiae) |
| STRN3 | 29966 | Striatin, calmodulin binding protein 3 |
| PYCARD | 29108 | PYD and CARD domain containing |
| HERC5 | 51191 | Hect domain and RLD 5 |
| MN1 | 4330 | Meningioma (disrupted in balanced translocation) 1 |
| XRCC2 | 7516 | X-ray repair complementing defective repair in Chinese hamster cells 2 |
| NOLC1 | 9221 | Nucleolar and coiled-body phosphoprotein 1 |
| CHFR | 55743 | Checkpoint with forkhead and ring finger domains |
| NHP2L1 | 4809 | NHP2 non-histone chromosome protein 2-like 1 (S. cerevisiae) |
| MCM7 | 4176 | Minichromosome maintenance complex component 7 |
| PIM2 | 11040 | Pim-2 oncogene |
| INHBA | 3624 | Inhibin, beta A |
| ACPP | 55 | Acid phosphatase, prostate |
| CETN3 | 1070 | Centrin, EF-hand protein, 3 (CDC31 homolog, yeast) |
| MIS12 | 79003 | MIS12, MIND kinetochore complex component, homolog (yeast) |
| PCAF | 8850 | P300/CBP-associated factor |
| PTMA | 5757 | Prothymosin, alpha (gene sequence 28) |
| AXL | 558 | AXL receptor tyrosine kinase |
| Sep-11 | 55752 | Septin |
| | | 11 |
| LTBP2 | 4053 | Latent transforming growth factor beta binding protein 2 |
| SUPT5H | 6829 | Suppressor of Ty 5 homolog (S. cerevisiae) |
| TOB2 | 10766 | Transducer of ERBB2, 2 |
| CDK5R1 | 8851 | Cyclin-dependent kinase 5, regulatory subunit 1 |
| | | (p35) |
| ILF3 | 3609 | Interleukin enhancer binding factor 3, 90 kDa |
| POLD1 | 5424 | Polymerase (DNA directed), delta 1, catalytic subunit 125 kDa |
| GADD45B | 4616 | Growth arrest and DNA-damage-inducible, beta |
| CDT1 | 81620 | Chromatin licensing and DNA replication factor 1 |

NRC_6 (cell motility)

| | | |
|---|---|---|
| KAL1 | 3730 | Kallmann syndrome 1 |
| | | sequence |
| PRSS3 | 5646 | Protease, serine, 3 (mesotrypsin) |
| CHL1 | 10752 | Cell adhesion molecule with homology to L1CAM (close homolog of L1) |
| ROBO1 | 6091 | Roundabout, axon guidance receptor, homolog 1 (Drosophila) |
| ZEB2 | 9839 | Zinc finger E-box binding homeobox 2 |
| EDG1 | 1901 | Endothelial differentiation, sphingolipid G-protein-coupled receptor, 1 |
| CDA | 978 | Cytidine deaminase |
| ATP1A3 | 478 | ATPase, Na+/K+ transporting, alpha 3 polypeptide |
| IGFBP7 | 3490 | Insulin-like growth factor binding protein 7 |
| INHBA | 3624 | Inhibin, beta A |
| CSPG4 | 1464 | Chondroitin sulfate proteoglycan 4 |
| WFDC1 | 58189 | WAP four-disulfide core domain 1 |
| PF4 | 5196 | Platelet factor 4 (chemokine (C—X—C motif) ligand 4) |
| ALOX12 | 239 | Arachidonate 12-lipoxygenase |
| NDN | 4692 | Necdin homolog (mouse) |
| CCDC88A | 55704 | Coiled-coil domain containing 88A |
| CEACAM1 | 634 | Carcinoembryonic antigen-related cell adhesion molecule 1 (biliary glycopro |
| ARPC3 | 10094 | Actin related protein 2/3 complex, subunit 3, 21 kDa |
| BCL6 | 604 | B-cell CLL/lymphoma 6 (zinc finger protein 51) |
| PPAP2B | 8613 | Phosphatidic acid phosphatase type 2B |
| LAMB1 | 3912 | Laminin, beta 1 |
| DNAH2 | 146754 | Dynein, axonemal, heavy chain 2 |
| SLIT3 | 6586 | Slit homolog 3 (Drosophila) |
| CDK5R1 | 8851 | Cyclin-dependent kinase 5, regulatory subunit 1 |
| | | (p35) |
| ADRA2A | 150 | Adrenergic, alpha-2A-, |
| | | receptor |
| AMOT | 154796 | Angiomotin |
| ACTG1 | 71 | Actin, gamma 1 |
| TGFB3 | 7043 | Transforming growth factor, beta 3 |
| KDR | 3791 | Kinase insert domain receptor (a type III receptor tyrosine |
| | | kinase) |
| ABI3 | 51225 | ABI gene family, member 3 |

NRC-7 (apoptosis)

| | | |
|---|---|---|
| CDH13 | 1012 | Cadherin 13, H-cadherin |
| | | (heart) |
| SLAMF7 | 57823 | SLAM family member 7 |
| ANGPTL4 | 51129 | Angiopoietin-like 4 |
| SULF1 | 23213 | Sulfatase 1 |
| GJA1 | 2697 | Gap junction protein, alpha 1, 43 kDa |
| MUC2 | 4583 | Mucin 2, oligomeric mucus/gel-forming |
| INPP5D | 3635 | Inositol polyphosphate-5-phosphatase, 145 kDa |
| BCL2L14 | 79370 | BCL2-like 14 (apoptosis facilitator) |
| CASP8AP2 | 9994 | CASP8 associated protein 2 |
| PTK2B | 2185 | PTK2B protein tyrosine kinase 2 beta |
| LIG4 | 3981 | Ligase IV, DNA, ATP- |
| | | dependent |
| GML | 2765 | GPI anchored molecule like protein |
| PDCD4 | 27250 | Programmed cell death 4 (neoplastic transformation inhibitor) |
| MAGEH1 | 28986 | Melanoma antigen family H, 1 |
| FAS | 355 | Fas (TNF receptor superfamily, member 6) |
| ANXA5 | 308 | Annexin A5 |
| GRM4 | 2914 | Glutamate receptor, metabotropic 4 |
| AVEN | 57099 | Apoptosis, caspase activation inhibitor |
| CASP9 | 842 | Caspase 9, apoptosis-related cysteine peptidase |
| CRYAA | 1409 | Crystallin, alpha A |
| NFKBIA | 4792 | Nuclear factor of kappa light polypeptide gene enhancer in B-cells inhibitor, |
| STK3 | 6788 | Serine/threonine kinase 3 (STE20 homolog, yeast) |
| PPP2CB | 5516 | Protein phosphatase 2 (formerly 2A), catalytic subunit, beta isoform |
| CIAPIN1 | 57019 | Cytokine induced apoptosis inhibitor 1 |
| PEA15 | 8682 | Phosphoprotein enriched in astrocytes 15 |
| TGFB2 | 7042 | Transforming growth factor, beta 2 |
| OLFR@ | 4972 | olfactory receptor cluster |
| MGC29506 | 51237 | Hypothetical protein |
| | | MGC29506 |
| CD74 | 972 | CD74 molecule, major histocompatibility complex, class II invariant chain |
| TRAF6 | 7189 | TNF receptor-associated factor 6 |

NRC-8 (cell adhesion)

| | | |
|---|---|---|
| SLAMF7 | 57823 | SLAM family member 7 |
| CDH13 | 1012 | Cadherin 13, H-cadherin |
| | | (heart) |
| IGSF1 | 3547 | Immunoglobulin superfamily, member 1 |
| TGFBI | 7045 | Transforming growth factor, beta-induced, 68 kDa |
| HAPLN1 | 1404 | Hyaluronan and proteoglycan link protein 1 |
| FRAS1 | 80144 | Fraser syndrome 1 |
| PLEKHC1 | 10979 | Pleckstrin homology domain containing, family C (with FERM domain) mem [symbol] |
| CD226 | 10666 | CD226 molecule |
| SUSD5 | 26032 | Sushi domain containing 5 |
| CELSR1 | 9620 | Cadherin, EGF LAG seven-pass G-type receptor 1 (flamingo homolog, Dros |
| GRLF1 | 2909 | Glucocorticoid receptor DNA binding factor 1 |
| NID2 | 22795 | Nidogen 2 (osteonidogen) |
| DDR1 | 780 | Discoidin domain receptor family, member 1 |
| NINJ2 | 4815 | Ninjurin 2 |
| DCHS2 | 54798 | Dachsous 2 (Drosophila) |
| ITGAM | 3684 | Integrin, alpha M (complement component 3 receptor 3 subunit) |
| SCARB2 | 950 | Scavenger receptor class B, member 2 |
| CYR61 | 3491 | Cysteine-rich, angiogenic inducer, 61 |
| PVRL2 | 5819 | Poliovirus receptor-related 2 (herpesvirus entry mediator B) |
| PTK2B | 2185 | PTK2B protein tyrosine kinase 2 beta |
| SELPLG | 6404 | Selectin P ligand |
| GP1BA | 2811 | Glycoprotein Ib (platelet), alpha |
| | | polypeptide |
| VCL | 7414 | Vinculin |
| CXCR3 | 2833 | Chemokine (C—X—C motif) receptor 3 |
| WFDC1 | 58189 | WAP four-disulfide core domain 1 |
| DLG1 | 1739 | Discs, large homolog 1 (Drosophila) |
| ENTPD1 | 953 | Ectonucleoside triphosphate diphosphohydrolase 1 |
| CTNNA3 | 29119 | Catenin (cadherin-associated protein), alpha 3 |
| PPFIA1 | 8500 | Protein tyrosine phosphatase, receptor type, f polypeptide (PTPRF), interacl |
| NF2 | 4771 | Neurofibromin 2 (bilateral acoustic neuroma) |

NRC-9 (cell growth)

| | | |
|---|---|---|
| WFDC1 | 58189 | WAP four-disulfide core domain 1 |
| CDH13 | 1012 | Cadherin 13, H-cadherin |
| | | (heart) |
| ETV4 | 2118 | Ets variant gene 4 (E1A enhancer binding protein, E1AF) |
| DDR1 | 780 | Discoidin domain receptor family, member 1 |
| PLEKHC1 | 10979 | Pleckstrin homology domain containing, family C (with FERM domain) mem [symbol] |
| SELPLG | 6404 | Selectin P ligand |
| CYR61 | 3491 | Cysteine-rich, angiogenic inducer, 61 |
| TKT | 7086 | Transketolase (Wernicke-Korsakoff syndrome) |
| VAX2 | 25806 | Ventral anterior homeobox 2 |
| RAI1 | 10743 | Retinoic acid induced 1 |
| SEMA6A | 57556 | Sema domain, transmembrane domain (TM), and cytoplasmic domain, (serr [symbol] |
| | | 6A |
| DLG1 | 1739 | Discs, large homolog 1 (Drosophila) |
| BTG1 | 694 | B-cell translocation gene 1, anti- |
| | | proliferative |
| PTCH1 | 5727 | Patched homolog 1 |
| | | (Drosophila) |
| FGF20 | 26281 | Fibroblast growth factor 20 |
| OGFR | 11054 | Opioid growth factor receptor |
| NINJ2 | 4815 | Ninjurin 2 |
| MORF4L2 | 9643 | Mortality factor 4 like 2 |
| VCL | 7414 | Vinculin |
| ESR2 | 2100 | Estrogen receptor 2 (ER beta) |
| OPHN1 | 4983 | Oligophrenin 1 |
| NTRK3 | 4916 | Neurotrophic tyrosine kinase, receptor, type 3 |
| CDKN2C | 1031 | Cyclin-dependent kinase inhibitor 2C (p18, inhibits CDK4) |
| CDK5R1 | 8851 | Cyclin-dependent kinase 5, regulatory subunit 1 |
| | | (p35) |
| TOP2B | 7155 | Topoisomerase (DNA) II beta 180 kDa |
| PPT1 | 5538 | Palmitoyl-protein thioesterase 1 (ceroid-lipofuscinosis, neuronal 1, infantile) |
| GDF2 | 2658 | Growth differentiation factor 2 |
| GFRA3 | 2676 | GDNF family receptor alpha 3 |
| GP1BA | 2811 | Glycoprotein Ib (platelet), alpha |
| | | polypeptide |
| PPP2CB | 5516 | Protein phosphatase 2 (formerly 2A), catalytic subunit, beta isoform |

[symbol]

indicates data missing or illegible when filed

TABLE 2
Performance of the validation of the marker sets in 3 testing datasets
ER+ sample

| Group | Test set 1 (173 samples)* | Test set 2 (74 samples) | Test set 3 (201 samples) |
|---|---|---|---|
| Low-risk | N = 99, R = 57.2%, | N = 22, R = 29.7%, | N = 87, R = 43.3%, |
| | R1 = 93.9% | R1 = 90.9% | R1 = 86.8% |
| Intermediate | N = 34, R = 19.6%, | N = 52, R = 70.3%, | N = 78, R = 38.8%, R1 = 69.2% |
| | R1 = 82.4% | R1 = 79.7% | |
| High-risk | N = 40, R = 23.1%, | — | N = 36, R = 17.9%, R2 = 33.3% |
| | R2 = 42.5% | | |

ER− sample

| Group | Test set 1 (46 samples)* | Test set 2 (43 samples) | Test set 3 (31 samples) |
|---|---|---|---|
| Low-risk | N = 9, R = 19.6%, | N = 13, R = 30.2%, | N = 14, R = 45.2%, R1 = 100% |
| | R1 = 100% | R1 = 92.3% | |
| High-risk | N = 37, R = 80.4%, | N = 30, R = 69.8%, | N = 17, R = 54.8%, R2 = 35.3% |
| | R2 = 51.4% | R2 = 40% | |

Notes:
*There are 295 samples in the original Test set 1. However, it includes 76 samples, which are from van't Veer et al., Nature, 415: 530, 2002. Because we used van't Veer dataset (van't Veer et al., Nature, 415: 530, 2002) as a training set, we then removed these 76 samples from the 295 samples. Therefore, Test set 1 contains 219 samples.
1. N represents sample number
2. R represents the ratio of the sample number in the group to the total sample number of test set
3. R1 represents the percentage of the samples having non-recurrence (accuracy)
4. R2 represents the percentage of the samples having recurrence (accuracy)
5. Test set 1 is from Chang et al., PNAS, 2005
6. Test set 2 is from Koe et al., Cancer Cell, 2006
7. Test set 3 is from Sotiriou et al., J. Natl Cancer Inst, 98: 262, 2006

TABLE 3
Comparisons of combinatory usage of marker sets and each
individual marker set for predicting low-risk group samples

| Marker set | Accuracy (in low-risk group) |
|---|---|
| | Test set 1 (173 samples) |
| NRC-1 | 92.80% |
| NRC-2 | 91.80% |
| NRC-3 | 92.20% |
| NRC-1, 2, 3 | 94% |
| | Test set 2 (74 samples) |
| NRC-1 | 86.80% |
| NRC-2 | 88.90% |
| NRC-3 | 78.30% |
| NRC-1, 2, 3 | 91% |
| | Test set 3 (201 samples) |
| NRC-1 | 83.10% |
| NRC-2 | 80.50% |
| NRC-3 | 79.50% |
| NRC-1, 2, 3 | 87% |

ER− samples

| | |
|---|---|
| | Test set 1 (46 samples)* |
| NRC-7 | 76% |
| NRC-8 | 72.70% |
| NRC-9 | 56.50% |
| NRC-7, 8, 9 | 100% |
| | Test set 2 (43 samples) |
| NRC-7 | 85% |
| NRC-8 | 84.20% |
| NRC-9 | 73.10% |
| NRC-7, 8, 9 | 92.30% |
| | Test set 3 (31 samples) |
| NRC-7 | 91% |
| NRC-8 | 100% |
| NRC-9 | 86.40% |
| NRC-7, 8, 9 | 100% |

Note:
The datasets used are the same as those in Table 2.

TABLE 4
List of Cancers

Acute Lymphoblastic Leukemia, Adult
Acute Lymphoblastic Leukemia, Childhood
Acute Myeloid Leukemia, Adult
Acute Myeloid Leukemia, Childhood
Adrenocortical Carcinoma
Adrenocortical Carcinoma, Childhood
AIDS-Related Cancers
AIDS-Related Lymphoma
Anal Cancer
Appendix Cancer
Astrocytomas, Childhood)
Atypical Teratoid/Rhabdoid Tumor, Childhood, Central
Nervous System
Basal Cell Carcinoma, see Skin Cancer
(Nonmelanoma)
Bile Duct Cancer, Extrahepatic
Bladder Cancer
Bladder Cancer, Childhood
Bone Cancer, Osteosarcoma and Malignant Fibrous
Histiocytoma
Brain Stem Glioma, Childhood
Brain Tumor, Adult
Brain Tumor, Brain Stem Glioma, Childhood
Brain Tumor, Central Nervous System Atypical
Teratoid/Rhabdoid Tumor, Childhood
Brain Tumor, Central Nervous System Embryonal
Tumors, Childhood
Brain Tumor, Craniopharyngioma, Childhood
Brain Tumor, Ependymoblastoma, Childhood
Brain Tumor, Ependymoma, Childhood
Brain Tumor, Medulloblastoma, Childhood
Brain Tumor, Medulloepithelioma, Childhood
Brain Tumor, Pineal Parenchymal Tumors of
Intermediate Differentiation, Childhood)
Brain Tumor, Supratentorial Primitive Neuroectodermal
Tumors and Pineoblastoma, Childhood
Brain and Spinal Cord Tumors, Childhood (Other)
Breast Cancer
Breast Cancer and Pregnancy
Breast Cancer, Childhood
Breast Cancer, Male
Bronchial Tumors, Childhood
Burkitt Lymphoma
Carcinoid Tumor, Childhood
Carcinoid Tumor, Gastrointestinal
Carcinoma of Unknown Primary
Central Nervous System Atypical Teratoid/Rhabdoid
Tumor, Childhood
Central Nervous System Embryonal Tumors, Childhood
Central Nervous System Lymphoma, Primary
Cervical Cancer
Cervical Cancer, Childhood
Childhood Cancers
Chordoma, Childhood
Chronic Lymphocytic Leukemia
Chronic Myelogenous Leukemia
Chronic Myeloproliferative Disorders
Colon Cancer
Colorectal Cancer, Childhood
Craniopharyngioma, Childhood
Cutaneous T-Cell Lymphoma, see Mycosis Fungoides
and Sézary Syndrome
Embryonal Tumors, Central Nervous System,
Childhood
Endometrial Cancer
Ependymoblastoma, Childhood
Ependymoma, Childhood
Esophageal Cancer
Esophageal Cancer, Childhood
Ewing Sarcoma Family of Tumors
Extracranial Germ Cell Tumor, Childhood
Extragonadal Germ Cell Tumor
Extrahepatic Bile Duct Cancer
Eye Cancer, Intraocular Melanoma
Eye Cancer, Retinoblastoma
Gallbladder Cancer
Gastric (Stomach) Cancer
Gastric (Stomach) Cancer, Childhood
Gastrointestinal Carcinoid Tumor
Gastrointestinal Stromal Tumor (GIST)
Gastrointestinal Stromal Cell Tumor, Childhood
Germ Cell Tumor, Extracranial, Childhood
Germ Cell Tumor, Extragonadal
Germ Cell Tumor, Ovarian
Gestational Trophoblastic Tumor
Glioma, Adult
Glioma, Childhood Brain Stem
Hairy Cell Leukemia
Head and Neck Cancer
Hepatocellular (Liver) Cancer, Adult (Primary)
Hepatocellular (Liver) Cancer, Childhood (Primary)
Histiocytosis, Langerhans Cell
Hodgkin Lymphoma, Adult
Hodgkin Lymphoma, Childhood
Hypopharyngeal Cancer
Intraocular Melanoma
Islet Cell Tumors (Endocrine Pancreas)
Kaposi Sarcoma
Kidney (Renal Cell) Cancer
Kidney Cancer, Childhood
Langerhans Cell Histiocytosis
Laryngeal Cancer
Laryngeal Cancer, Childhood
Leukemia, Acute Lymphoblastic, Adult
Leukemia, Acute Lymphoblastic, Childhood
Leukemia, Acute Myeloid, Adult
Leukemia, Acute Myeloid, Childhood
Leukemia, Chronic Lymphocytic
Leukemia, Chronic Myelogenous
Leukemia, Hairy Cell
Lip and Oral Cavity Cancer
Liver Cancer, Adult (Primary)
Liver Cancer, Childhood (Primary
Lung Cancer, Non-Small Cell
Lung Cancer, Small Cell
Lymphoma, AIDS-Related
Lymphoma, Burkitt
Lymphoma, Cutaneous T-Cell, see Mycosis Fungoides
and Sezary Syndrome
Lymphoma, Hodgkin, Adult
Lymphoma, Hodgkin, Childhood
Lymphoma, Non-Hodgkin, Adult
Lymphoma, Non-Hodgkin, Childhood
Lymphoma, Primary Central Nervous System
Macroglobulinemia, Waldenstrom
Malignant Fibrous Histiocytoma of Bone and
Osteosarcoma
Medulloblastoma, Childhood
Medulloepithelioma, Childhood
Melanoma
Melanoma, Intraocular (Eye)
Merkel Cell Carcinoma
Mesothelioma, Adult Malignant
Mesothelioma, Childhood
Metastatic Squamous Neck Cancer with Occult Primary
Mouth Cancer
Multiple Endocrine Neoplasia Syndrome, Childhood
Multiple Myeloma/Plasma Cell Neoplasm
Mycosis Fungoides
Myelodysplastic Syndromes
Myelodysplastic/Myeloproliferative Neoplasms
Myelogenous Leukemia, Chronic
Myeloid Leukemia, Adult Acute
Myeloid Leukemia, Childhood Acute
Myeloma, Multiple
Myeloproliferative Disorders, Chronic
Nasal Cavity and Paranasal Sinus Cancer
Nasopharyngeal Cancer
Nasopharyngeal Cancer, Childhood
Neuroblastoma
Non-Hodgkin Lymphoma, Adult
Non-Hodgkin Lymphoma, Childhood
Non-Small Cell Lung Cancer
Oral Cancer, Childhood
Oral Cavity Cancer, Lip and
Oropharyngeal Cancer
Osteosarcoma and Malignant Fibrous Histiocytoma of
Bone
Ovarian Cancer, Childhood
Ovarian Epithelial Cancer
Ovarian Germ Cell Tumor
Ovarian Low Malignant Potential Tumor
Pancreatic Cancer
Pancreatic Cancer, Childhood
Pancreatic Cancer, Islet Cell Tumors
Papillomatosis, Childhood
Paranasal Sinus and Nasal Cavity Cancer
Parathyroid Cancer
Penile Cancer
Pharyngeal Cancer
Pineal Parenchymal Tumors of Intermediate
Differentiation, Childhood
Pineoblastoma and Supratentorial Primitive
Neuroectodermal Tumors, Childhood
Pituitary Tumor
Plasma Cell Neoplasm/Multiple Myeloma
Pleuropulmonary Blastoma
Pregnancy and Breast Cancer
Primary Central Nervous System Lymphoma
Prostate Cancer
Rectal Cancer
Renal Cell (Kidney) Cancer
Renal Cell (Kidney) Cancer, Childhood
Renal Pelvis and Ureter, Transitional Cell Cancer
Respiratory Tract Carcinoma Involving the NUT Gene
on Chromosome 15
Retinoblastoma
Rhabdomyosarcoma, Childhood
Salivary Gland Cancer
Salivary Gland Cancer, Childhood
Sarcoma, Ewing Sarcoma Family of Tumors
Sarcoma, Kaposi
Sarcoma, Soft Tissue, Adult
Sarcoma, Soft Tissue, Childhood
Sarcoma, Uterine
Sezary Syndrome
Skin Cancer (Nonmelanoma)
Skin Cancer, Childhood
Skin Cancer (Melanoma)
Skin Carcinoma, Merkel Cell
Small Cell Lung Cancer
Small Intestine Cancer
Soft Tissue Sarcoma, Adult
Soft Tissue Sarcoma, Childhood
Squamous Cell Carcinoma, see Skin Cancer
(Nonmelanoma)
Squamous Neck Cancer with Occult Primary,
Metastatic
Stomach (Gastric) Cancer
Stomach (Gastric) Cancer, Childhood
Supratentorial Primitive Neuroectodermal Tumors,
Childhood
T-Cell Lymphoma, Cutaneous,
Testicular Cancer
Throat Cancer
Thymoma and Thymic Carcinoma
Thymoma and Thymic Carcinoma, Childhood
Thyroid Cancer
Thyroid Cancer, Childhood
Transitional Cell Cancer of the Renal Pelvis and Ureter
Trophoblastic Tumor, Gestational
Ureter and Renal Pelvis, Transitional Cell Cancer
Urethral Cancer
Uterine Cancer, Endometrial
Uterine Sarcoma
Vaginal Cancer
Vaginal Cancer, Childhood
Vulvar Cancer
Waldenström Macroglobulinemia
Wilms Tumor

We claim:

1. A process to identify tumour characteristics, said process comprising the following steps:
1) obtaining three different marker sets each predictive of a characteristic of interest;
2) obtaining a sample gene expression signals from tumour cells;
3) adding a reporter to affect a change in the sample permitting assessment of a gene expression signal of interest in the tumour;
4) combining the gene expression signals with the reporter;
5) correlating the extracted gene expression signals to the three different marker sets;
6) assigning a designation to the extracted gene expression signals according to the following rankings:
a. if the correlation of all three predictive gene expression signal sets predict it to have characteristics of concern, it is designated a bad tumour;
b. if the correlation of all three predictive gene expression signal sets predict it to lack characteristics of concern it is designated a good tumour;
c. if the correlation of all three predictive gene expression signal sets do not provide the same predicted clinical outcome, the tumour is designated as “intermediate”;
7) outputting said designation.

2. The process of claim 1 wherein a characteristic of concern relates to one or more of: metastasize, inflammation, cell cycle, immunological response genes, drug resistance genes, and multi-drug resistance genes.

3. The process of claim 1 wherein the tumour characteristic is a tendency to lead to poor patient survival post-surgery.

4. The process of claim 3 wherein step 4 comprises assigning a value to the extracted gene expression signals according to the following rankings:
a. if the correlation of all three predictive gene expression signal sets predict it to be a bad tumour, it is designated a bad tumour and more aggressive treatment beyond the typical standard of care would be recommended;
b. if the correlation of all three predictive gene expression signal sets predict it to be a good tumour, no treatment beyond the standard of care would be recommended and no post-surgery chemotherapy or radiation treatment would be recommended;
c. if the correlation of all three predictive gene expression signal sets do not provide the same prognosis, the tumour is designated as “intermediate” and the full typical standard of care treatment, including chemotherapy and/or radiation treatment would be recommended.

5. The process of claim 1 comprising the preliminary steps, prior to step 1, of:
a) identifying the tumour subtype to be examined
b) selecting marker sets specific to that subtype of tumour.

6. A process for determining predictive gene expression signal sets of the type used in claim 1 comprising the following steps:
1) obtaining gene expression signal information and patient clinical information for a characteristic of interest for a known tumour population for a cancer of interest;
2) correlating the gene expression signals with clinical patient information regarding the characteristic of interest to identify which genes have predictive power for clinical outcome;
3) creating at least 30 random training datasets from the identified gene expression signals;
4) comparing identified gene expression signals of step 1 to a list of known genes active in cancer;
5) selecting identified gene expression signals which correspond to those on the list of known cancer genes;
6) grouping the selected identified gene expression signals according to their role in biological processes;
7) generating random gene expression signal sets of at least 25 genes from a selected gene expression signals group of step 6;
8) correlating the random gene expression signal sets to the random training datasets obtained in step 3;
9) obtaining a P value for a survival screening from the correlation for each gene expression signal set of step 7;
10) if the P value for a gene expression signal set is less than 0.05 for more than 90% of the random training datasets, keeping the gene expression signal set;
11) ranking the random gene expression signal sets kept in step 10 based on frequency of gene appearances in the set;
12) selecting the top at least 26 genes as potential candidate markers;
13) repeating steps 7 to 12 and producing another, independent, rank set of at least 26 genes;
14) comparing the top genes from step 12 and step 13;
15) if more than 25 of the genes are the same, the top genes are kept as marker sets;
16) twice repeating steps 7 to 15 to obtain three different marker sets;
17) outputting said three different marker sets.

7. The process of claim 6 where the grouping of selected identified gene expression signals according to their role in biological process is done using Gene Ontology analysis.

8. The process of claim 6 wherein in step 3, between 30 and 50 random training sets are created.

9. The process of claim 8 wherein between 30 and 40 training sets are created.

10. The process of step 6 wherein in step 4, the genes know to be active in cancer are selected from the groups of genes responsible for metastasis, cell proliferation, tumour vascularisation, and drug response.

11. The process of claim 6 wherein in step 7, between about 750,000 and 1,250,000 random gene expression signal sets are generated.

12. The process of claim 6 wherein in step 7, between about 900,000 and 1,100,000 random gene expression signal sets are generated.

13. The process of claim 6 wherein in step 7, about 1,000,000 random gene expression signal sets are generated.

14. The process of claim 6 wherein in step 7, the random gene expression signal sets generated contain between about 25 and 50 genes.

15. The process of claim 6 wherein in step 7, the random gene expression signal sets generated contain between about 28 and 32 genes.

16. The process of claim 6 wherein in step 12 the top 26-50 genes are selected.

17. The process of claim 6 wherein in step 12 the top 28-32 genes are selected.

18. The process of claim 1 wherein the tumour is a mammalian tumour.

19. The process of claim 18 wherein the tumour is a tumour of one of:
human, ape, cat, dog, pig, cattle, sheep, goat, rabbit, mouse, rat, guinea pig, hamster, or gerbil.

20. The process of claim 4 wherein at least one the cancer biomarker set is selected from the list consisting essentially of NRC-1, NRC-2, NRC-3, NRC-4, NRC-5, NRC-6, NRC-7, NRC-8, and NRC-9.

21. A kit comprising at least three marker sets and instructions to carry out the process of claim 1.

22. The kit of claim 21, said kit comprising at least 10 gene expression signals listed in Table 1A or 1B.

23. The kit of claim 21 containing at least 30 nucleic acid biomarkers identified according to the method of claim 6.

24. Use of any of the sequences in Table 1A or 1B in identifying one or more tumour characteristics of interest.

25. The use of claim 23 wherein at least three different markers sets are used.

26. The method of claim 5 wherein the cancer biomarkers are breast cancer biomarkers and the first subtype of sample is an ER+ sample.

27. The method of claim 5 wherein the random training sets are generated by randomly picking samples while maintaining the same ratio of “good” and “bad” tumours as that in the other set from which they are chosen.

28. The method of claim 1 where all gene expression values designated as a bad tumours are grouped and the following steps are performed:
1) creating at least 30 random training datasets from identified gene expression signals;
2) comparing identified gene expression signals of the new group to a list of known genes active in cancer;
3) selecting identified gene expression signals which correspond to those on the list of known cancer genes;
4) grouping the selected identified gene expression signals according to their role in biological processes;
5) generating random gene expression signal sets of at least 25 genes from a selected gene expression signals group of step 4;
6) correlating the random gene expression signal sets to the random training datasets obtained in step 1;
7) obtaining a P value for a survival screening from the correlation for each gene expression signal set of step 6;
8) if the P value for a gene expression signal set is less than 0.05 for more than 90% of the random training datasets, keeping the gene expression signal set;
9) ranking the random gene expression signal sets kept in step 8 based on frequency of gene appearances in the set;
10) selecting the top at least 26 genes as potential candidate markers;
11) repeating steps 5 to 10 and producing another, independent, rank set of at least 26 genes;
12) comparing the top genes from step 10 and step 11;
13) if more than 25 of the genes are the same, the top genes are kept as marker sets;
14) twice repeating steps 5 to 13 to obtain three new and different marker sets;
15) outputting said three different, new marker sets.
